(19) United States
(12) Patent Application Publication
(10) Pub. No.: US 2007/0263073 A1
(43) Pub. Date: Nov. 15, 2007

(54) SYSTEM AND METHOD FOR IDENTIFYING THE REACHABILITY STATUS OF IP AND SIP BASED VIDEOCONFERENCING SYSTEMS

(75) Inventors: Alain Nimri, Austin, TX (US); Tanvir Rahman, Austin, TX (US)

Correspondence Address: WONG, CABELLO, LUTSCH, RUTHERFORD & BRUCCULERI,;L.L.P., 20333 SH 249, SUITE 600, HOUSTON, TX, 77070, US

(73) Assignee: Polycom, Inc., Pleasanton, CA (US)

(21) Appl. No.: 11/277,912

(22) Filed: Mar. 29, 2006

(51) Int. Cl. H04N 7/14

(52) U.S. Cl. 348/14.08

(57) ABSTRACT

A videoconferencing system includes a first videoconferencing unit and one or more second videoconferencing units, each of which is coupled to one or more networks. The first videoconferencing unit includes a computer network tool for pinging the one or more second videoconferencing units to determine whether the one or more second videoconferencing units are reachable on the network. The one or more second videoconferencing units include a computer network tool for automatically responding to the ping by sending a response to the first videoconferencing unit.

### FIELD OF THE DISCLOSURE

The subject matter of the present disclosure relates to a system and method for identifying the reachability status of IP and SIP based videoconferencing systems.

### BACKGROUND OF THE DISCLOSURE

Videoconferencing systems use address information such as Internet Protocol (“IP”) addresses or Session Initiation Protocol (“SIP”) addresses to establish connections between them. However, a videoconferencing unit whose address information is known may not always be reachable. A videoconferencing unit may be unreachable because it is behind a firewall on the network, because the IP address is established by a private network, or because the unit is turned off or otherwise disconnected. Without prior knowledge of the reachability status of potential participants, users must attempt to contact another videoconferencing unit to determine if the other videoconferencing unit is available. Attempting to contact the other videoconferencing unit may require a time-intensive series of actions. For example, some videoconferencing units have an address list feature which allows the user to choose between entries which are stored in the videoconferencing unit's local memory and possibly displayed on a screen. To attempt to connect with another videoconferencing unit, a user may have to access an address list feature on the videoconferencing unit, select potential participants of the videoconference, and then wait for an attempted connection. Repeating these time-intensive steps for unreachable videoconferencing units wastes time. Even more time may be used if address list entries are loaded from remote servers, which some videoconferencing units are capable of, because many of the potential participants represented by these entries may be unreachable.

Not knowing if another videoconferencing unit is reachable may also be disadvantageous because unreachable videoconferencing units may be displayed on the same screen with reachable conferencing units as potential participants, making the screen more difficult to read.

The subject matter of the present disclosure is directed to overcoming, or at least reducing the effects of, one or more of the problems set forth above.

### SUMMARY OF THE DISCLOSURE

A videoconferencing system includes a first videoconferencing unit and one or more second videoconferencing units, each of which is coupled to one or more networks. The first videoconferencing unit includes a computer network tool for pinging the one or more second videoconferencing units to determine whether the one or more second videoconferencing units are reachable on the network. The one or more second videoconferencing units include a computer network tool for automatically responding to the ping by sending a response to the first videoconferencing unit.

Upon activation, the first videoconferencing unit automatically obtains one or more videoconferencing addresses for the one or more second videoconferencing units from an address list feature of the first videoconferencing unit. The videoconferencing address can include, but may not be limited to, the Internet Protocol (“IP”) address or the Session Initiation Protocol (“SIP”) address of the second videoconferencing unit. The address can be fixed, or it can change depending on how the second videoconferencing unit is assigned its videoconferencing address.

The first videoconferencing unit automatically configures and sends an echo response request data packet, such as, for example, an echo response request according to the Ping utility, to each of the one or more second videoconferencing units at the one or more IP addresses and listens for responses from the units. The one or more second videoconferencing units which receive the echo response request data packet automatically respond to receiving the data packet by sending an echo response data packet, such as, for example, an echo response according to the Ping utility, to the first videoconferencing unit.

Upon receiving one or more second videoconferencing units' responses, the first videoconferencing unit flags as reachable the responding units of the one or more second videoconferencing units. If a response from some of the one or more second videoconferencing units is not received after a configurable amount of time, a configurable number of retries, or a combination of these, the videoconferencing units for which a response has not been received are flagged as unreachable. In some implementations, those one or more second videoconferencing units that are flagged as reachable are displayed for the user, and those one or more second videoconferencing units that are flagged as unreachable are not displayed. In other implementations, those one or more second videoconferencing units that are flagged as reachable are displayed differently than those flagged as unreachable.

The foregoing summary is not intended to summarize each potential embodiment or every aspect of the present disclosure.

### BRIEF DESCRIPTION OF THE DRAWINGS

The foregoing summary, preferred embodiments, and other aspects of subject matter of the present disclosure will be best understood with reference to a detailed description of specific embodiments, which follows, when read in conjunction with the accompanying drawings, in which:

FIG. 1 illustrates an embodiment of a videoconferencing system according to certain teachings of the present disclosure.

FIGS. 2A and 2B set forth a data flow diagram illustrating a process of operation of the disclosed videoconferencing system.

FIG. 3 illustrates an example of a graphical user interface for initiating a videoconference according to the present disclosure.

FIG. 4 sets forth an illustrative echo response request format for requesting an echo response data packet from a videoconferencing unit.

FIG. 5 sets forth an illustrative echo response format for responding to an echo response request data packet from a videoconferencing unit.

While the subject matter of the present disclosure is susceptible to various modifications and alternative forms, specific embodiments thereof have been shown by way of example in the drawings and are herein described in detail. The figures and written description are not intended to limit the scope of the inventive concepts in any manner.

### DETAILED DESCRIPTION

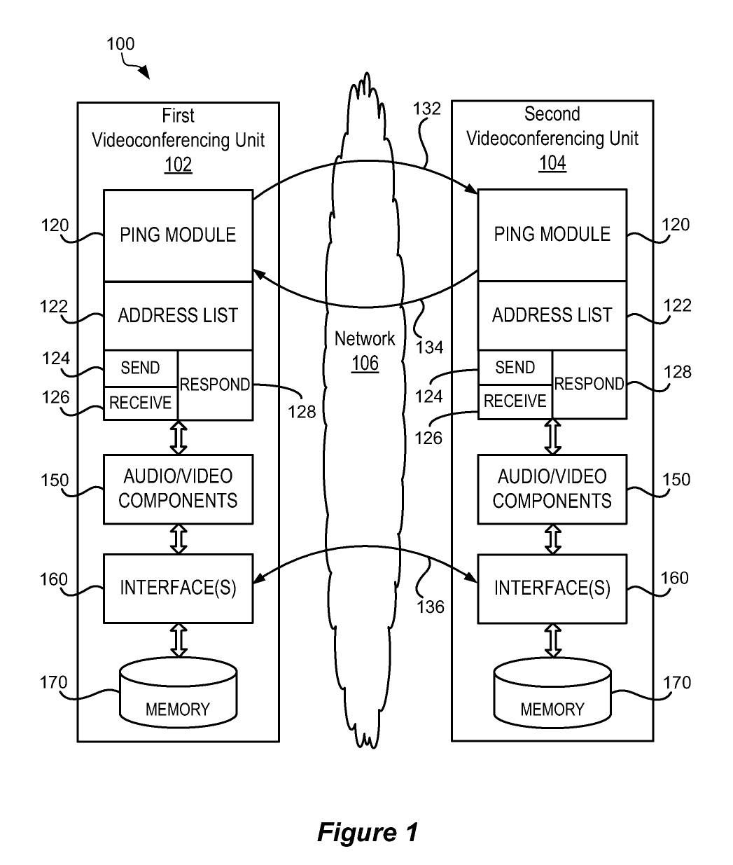

Referring to FIG. 1, a videoconferencing system according to certain teachings of the present disclosure is schematically illustrated. The videoconferencing system of FIG. 1 uses echo response request data packets 132 and echo response data packets 134, or lack thereof, between videoconferencing unit 102 and one or more recipient videoconferencing units 104 to inform the first videoconferencing unit 102 of the reachability status (i.e., whether or not the second unit 104 is reachable) of the one or more second videoconference units 104. The echo response request data packets 132 and echo response data packets 134 are sent to the one or more recipient videoconferencing units 104 and the videoconferencing unit 102, respectively, by using IP or SIP addresses (collectively “address information”). The echo response request data packets 132 and echo response data packets 134 propagate through one or more communications networks, such as, for example, the Internet.

Each unit 102 and 104 includes a ping module 120 as an internal component of its software. The ping module 120 of each unit 102 and 104 has an address list function 122 for obtaining one or more IP addresses representing one or more videoconferencing units and has a send function 124 for sending echo response request data packets 132 to each IP address. The ping module 120 also has a receive function 126 for identifying and tracking echo response data packets 134 sent from the second videoconferencing units received by the first videoconferencing unit 102. The ping module 120 also has a respond function 128 for automatically responding to echo response request data packets 132 from another videoconferencing unit. The send function 124 for sending echo response request data packets 132, although it can be initiated by the user, is preferably operated automatically by the ping module 120 of the videoconferencing units 102 and 104. For example, the send function 124 preferably generates echo response request data packets 132 and sends them to the selected recipient unit(s) 104.

The send function 124 and the respond function 128 may send data packets addressed to a specific port, such as, for example, port 1720 for IP-based systems and port 5060 for SIP-based systems. Alternatively, the send function 124 and the respond function 128 may send data packets addressed to a port according to any other assignment scheme.

Likewise, the receive function 126 is preferably operated automatically by the ping module 120 of the units 102 and 104. For example, the receive function 126 preferably identifies and tracks data packets 134 automatically. To identify an echo response data packet 134, the receive function 126 can parse the code of the data packet 134 and can identify the IP address the data packet was sent from.

The second videoconferencing unit 104 associated with the IP address from the received response data packet is then flagged as reachable. IP addresses for which no response data packet is received within a configurable time are flagged as unreachable.

The respond function 128 is also preferably operated automatically by the ping module 120 of the units 102 and 104. For example, the respond function 128 preferably responds to an echo response request data packet 132 with an echo response 134 automatically. To identify an echo response request data packet 132, the respond function 128 can parse the code of the data packet 132 and can identify the address information from the data packet, giving the address from which the packet was sent.

The videoconferencing units 102 and 104 also include audio and video components 150, one or more network interfaces 160, a processor (not shown), and a database or memory 170. The memory 170 can store videoconferencing connection information, including IP addresses and SIP addresses, and other details related to establishing a videoconference call with the associated videoconferencing unit 102 and 104. The audio and video components 150 can be those components known in the art for handling audio and video of a videoconference. For example, the audio and video components 150 can include software and circuitry for encoding, decoding, compressing, and decompressing audio and video signals for a videoconference session. Likewise, the network interface 160 can include those components known in the art for handling communications 136 of a videoconference. Accordingly, the audio and video components 150 and the network interfaces 160 are not described in detail herein.

In FIG. 1, the data packets 132 and 134 are shown being transmitted from ping modules 120. In some implementations, each unit 102 and 104 may use the same network interface 160 for handling both data packets 132 and 134 and videoconference calls 136. It will be appreciated that each unit 102 and 104 can alternatively have more than one interface 160 for handling videoconference calls 136 and data packets 132 and 134.

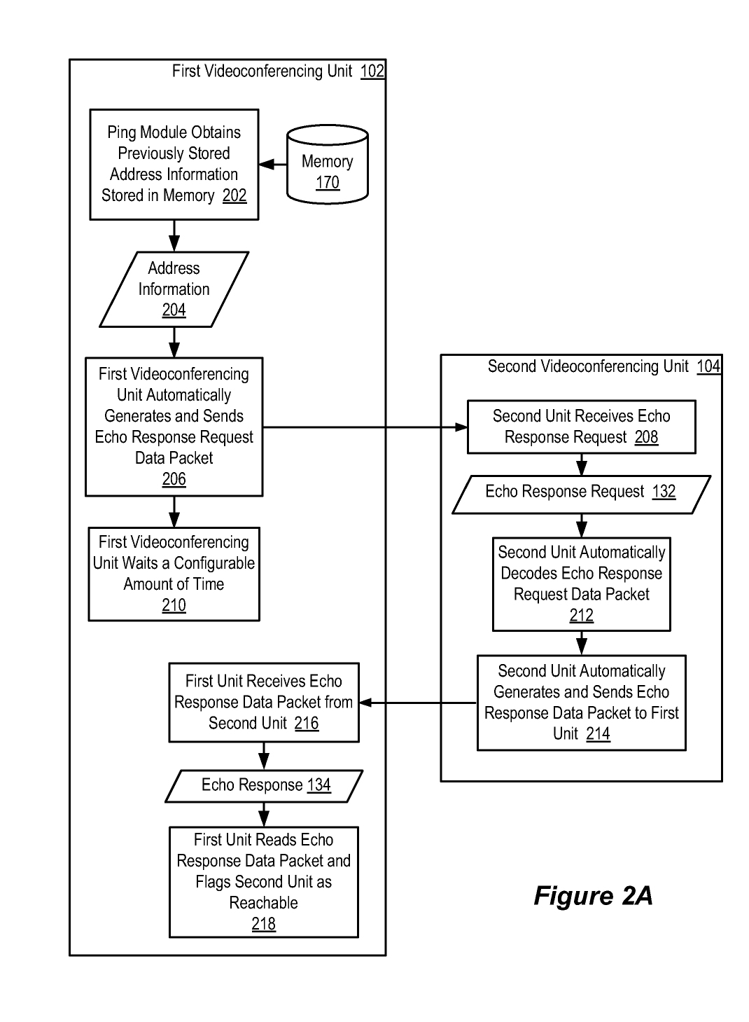

FIG. 2A sets forth a data flow diagram illustrating a process of operation of the disclosed videoconferencing system in determining that videoconferencing unit is reachable. (Reference numerals of elements in FIG. 1 are concurrently provided in the discussion of FIG. 2A). In the discussion that follows, it is assumed that a user at a first videoconferencing unit 102 wants to establish a videoconference call with a user at a second videoconferencing unit 104, but the user wants to know the reachability status of the second unit 104 before attempting to connect. Both units 102 and 104 have ping modules 120 internal to their software, and each unit 102 and 104 has an assigned IP or SIP address.

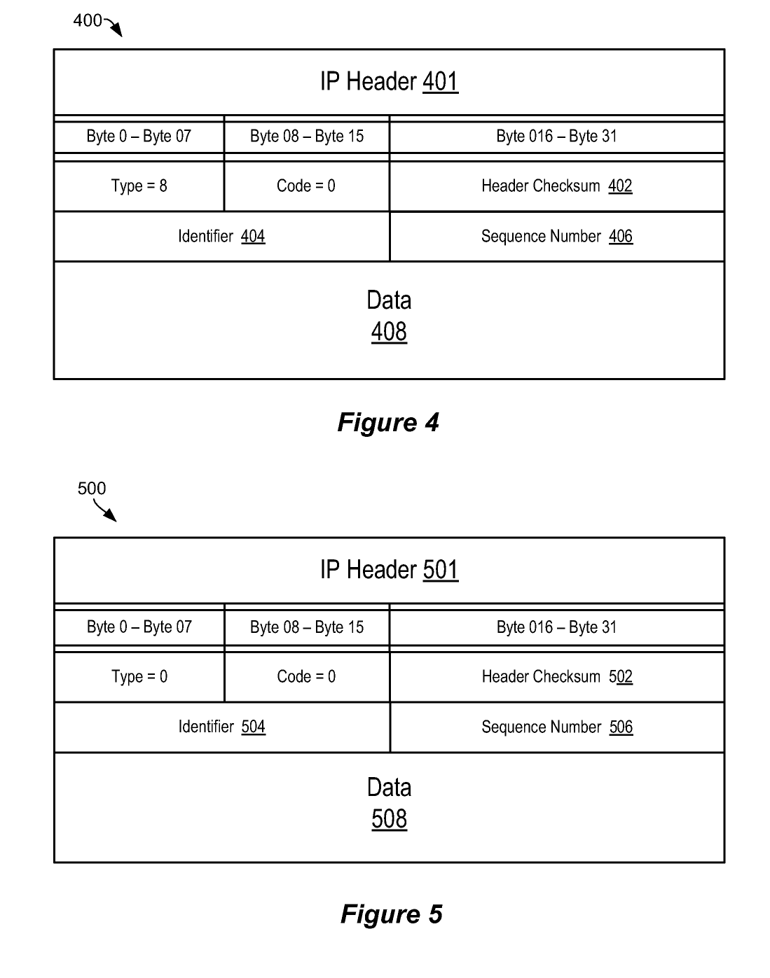

Upon activation, ping module 120 of videoconferencing unit 102 obtains 202 previously stored address information 204 of the second videoconferencing unit 104 stored in memory 170 of unit 102 by using the address list function 122. Once ping module 120 has obtained the address information 204 of a potential videoconference participant (first videoconferencing unit 104), videoconferencing unit 102 automatically generates and sends 206 echo response request data packets 132 to the address information 204 using the send function 124. The send function 124 automatically constructs the echo response request data packets 132 in a predefined format using an appropriate coding language for the echo response request data packets 132. An exemplary format for echo response request data packets 132 is discussed below with reference to FIG. 5. After generating and sending the echo response request data packets 132, the first videoconferencing unit 102 waits 210 a configurable amount of time after sending the data packets 132 for a response.

After the echo response request data packet 132 is sent, the second videoconferencing unit 104 receives 208 the echo response request data packet 132, and the second videoconferencing unit 104 automatically decodes 212 the echo response request data packet 132 and generates and sends 214 an echo response data packet 134 to the address information of the first videoconferencing unit 102 in reply. An exemplary format for an echo response request data packet 132 is discussed below with reference to FIG. 5.

The first videoconferencing unit 102 receives 216 the echo response data packet 134. The first videoconferencing unit 102 reads 218 the echo response data packet 134 to determine the sender by the address information and flags the sender, the second videoconferencing unit, as reachable.

As explained above, videoconferencing unit 104 may be unreachable for various reasons. FIG. 2B, therefore, sets forth a data flow diagram illustrating a process of operation of the disclosed videoconferencing system in determining that videoconferencing unit is unreachable. (Reference numerals of elements in FIG. 1 are concurrently provided in the discussion of FIG. 2). The design and operation of the system of FIG. 2B is identical to the operation of the system of FIG. 2A in sending an echo response request data packet to the second videoconferencing unit 104. The description of the system of FIG. 2A in sending an echo response request data packet to the second videoconferencing unit 104, therefore, applies to the system of FIG. 2B as denoted by identical reference numerals of FIG. 2B corresponding to those of FIG. 2A.

The echo response request 132 of FIG. 2B, unlike that of FIG. 2A, does not arrive 220 at the second videoconferencing unit 104. Being unreachable, the second videoconferencing unit 104 of the method of FIG. 2B does not receive 222 the echo response request data packet 132, and, therefore, the second videoconferencing unit 104 does not send a reply to the first videoconferencing unit 102. When an echo response data packet 134 from a second videoconferencing unit is not received by the first videoconferencing unit 102, after a configurable amount of time 226 the first unit 104 flags 224 the second videoconferencing unit 104 as unreachable. When an echo response data packet 134 is not received, the first unit 104 may alternatively send another echo response request 132. The first unit 104 may send a configurable number of retries, or send retries for a configurable amount of time before flagging 224 the second videoconferencing unit 104 as unreachable.

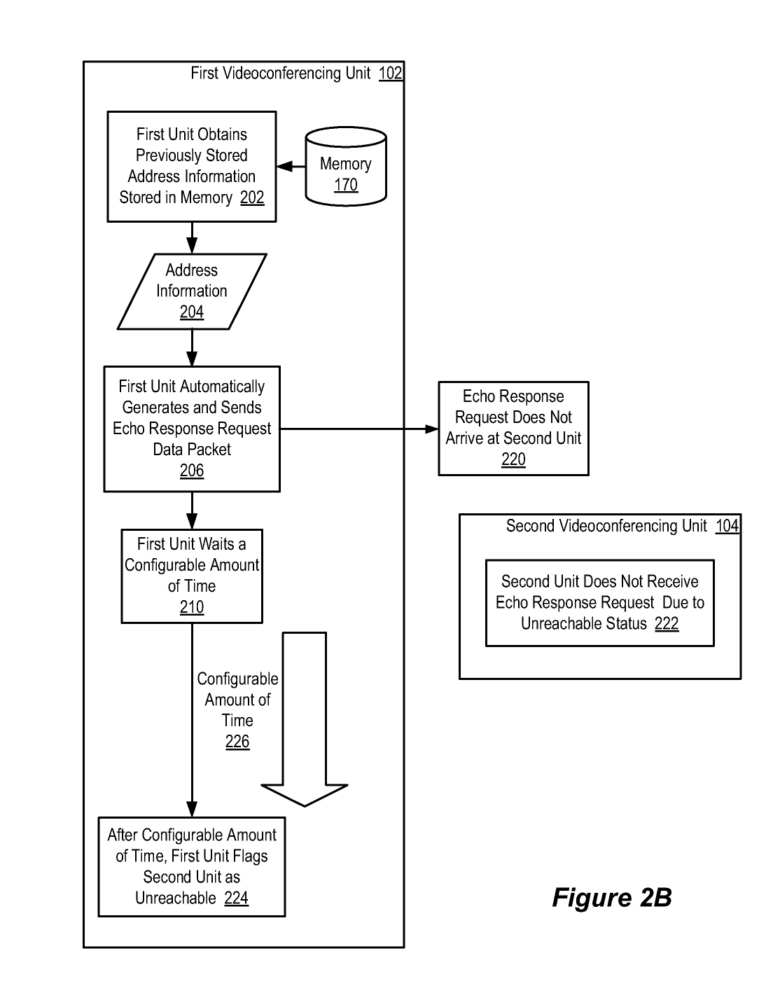

In some embodiments, a user at a videoconferencing unit can initiate contact with potential participants by selecting the address information of other videoconferencing units, or an alias representing that address information. Referring to FIG. 3, an example of a screen 300 for entering or selecting a videoconferencing unit by address information 304 or alias 302 to initiate a videoconference is illustrated. In this screen 300, which is accessible using a user interface for a videoconferencing unit, the user can select potential participants 310 and 312 in a videoconference. The potential participants 310 and 312 are displayed by address information 304 or alias 302 of one or more other videoconferencing units with which the user wishes to initiate a videoconference. A potential participant is selected by toggling a check-box 306 or 308 next to the representation of the potential participants 310 and 312 to a “checked” status. Toggling the status of a check-box 306 and 308 may be carried out by performing a mouse-click on the check box. Note that potential participant 310 is selected, as check-box 306 is toggled on, while potential participant 312 is not selected, as check-box 308 is toggled off. Potential participants that have been identified as unreachable 314 are not able to be selected. In alternate embodiments of the present disclosure, potential participants that have been identified as unreachable 314 are not displayed.

More videoconferencing units can be added by selecting an Add Participant button 316. The user can select an “add participant” button 316 and access an “add participant” screen (not shown) that facilitates adding possible participants. When the user has selected all the desired videoconferencing units to participate, the user can finish the selection process by selecting a button 320 to initiate a videoconferencing session with the videoconferencing units 310.

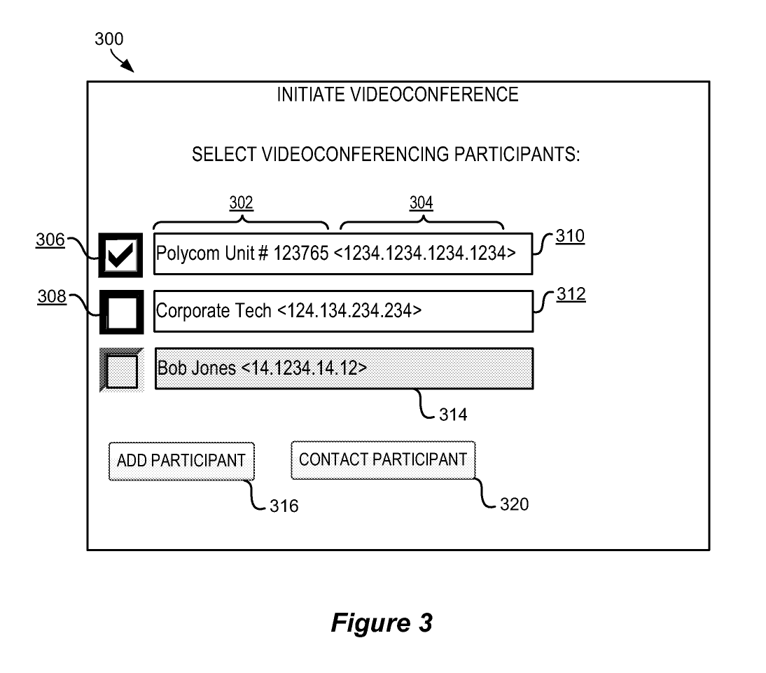

As discussed previously, an echo response request data packet is sent from one videoconferencing unit to another to request a response indicating that the receiving videoconference unit is reachable. An echo response request is used by a ping tool, in conjunction with an echo response, to determine whether a host is reachable. For further explanation, therefore, FIG. 4 sets forth an illustrative echo response request 400 format for requesting an echo response data packet from a videoconferencing unit. The echo response request 400 is illustrated in pseudo-code for convenience, but it is understood that the actual echo response request includes data packets formatted according to the Internet Control Message Protocol (“ICMP”), defined by Internet Engineering Task Force (“IETF”) Request for Comment (“RFC”) 792, or other suitable protocol, for example. The details and format are provided for illustrative purposes, and the echo response request can have any details and format commensurate with the teachings of the present disclosure.

The echo response request 400 is an ICMP control message which requests that an echo response control message be sent from the receiving unit. ICMP is one of the core protocols of the Internet protocol suite. ICMP is often used by an operating system to send networking error messages. The echo response request 400 is a data packet beginning with a standard IP header 401 containing the address information of both the sending and receiving videoconferencing unit, followed by an 8-bit type designation equivalent to the decimal value 8, an 8-bit code designation equivalent to the decimal value 0, and a 16-bit header checksum 402. The next thirty-two bits of the data packet are equally divided between an identifier 404 and a sequence number 406. Data 408 follows the sequence number 406.

The checksum 402 may be the 16-bit ones' complement of the ones' complement sum of the ICMP message starting with the ICMP type. If the total length is odd, the received data may be padded with one octet of zeros for computing the checksum. Many other checksums may be used in the alternative. The identifier 404 and sequence number 406 may be used by the first videoconferencing unit to aid in matching the replies with the echo requests. For example, the identifier 404 may be used like a port number to identify a session, and the sequence number 406 may be incremented on each echo request sent. The second videoconferencing unit returns these same values in the echo reply. The data 408 received in the echo response request 400 may be required to be returned in the echo response.

As discussed previously, an echo response request data packet is sent from one videoconferencing unit to another to request a response indicating that the receiving videoconference unit is reachable. For further explanation, therefore, FIG. 5 sets forth an illustrative echo response 500 format for responding to an echo response request data packet from a videoconferencing unit. The echo response 500 is illustrated in pseudo-code for convenience, but it is understood that the actual echo response request includes data packets formatted according to the Internet Control Message Protocol (“ICMP”), defined by IETF RFC 792, or other suitable protocol, for example. The details and format are provided for illustrative purposes, and the echo response can have any details and format commensurate with the teachings of the present disclosure.

As discussed previously, an echo response 500 is used by a ping tool. Like the echo response request, the echo response 500 is an ICMP control message. The echo response 500 signifies that an echo response control message was received by another videoconferencing unit and is reachable. The echo response 500 is a data packet beginning with a standard IP header 501 containing the address information of both the sending and receiving videoconference units, followed by an 8-bit type designation equivalent to the decimal value 0, an 8-bit code designation equivalent to the decimal value 0, and a 16-bit header checksum 502. The next thirty-two bits of the data packet are equally divided between an identifier 504 and a sequence number 506. Data 508 follows the sequence number 506.

The checksum 502 is typically similar to the checksum used in the echo response request, as described above. The identifier 504 and sequence number 506 may be used by the first videoconferencing unit to aid in matching the replies with the echo requests. The echoer returns the values in identifier 504 and the sequence number 506 in the echo response 500. The data 408 (FIG. 4) received in the request may be required to be returned in the data 508 field of the echo response 500. The address of the source in an echo message will be the destination of the echo reply message. Forming an echo response 500 from an echo response request 400 may be carried out by reversing the source and destination addresses, changing the type code to 0, and recomputing the checksum.

The foregoing description of preferred and other embodiments is not intended to limit or restrict the scope or applicability of the inventive concepts conceived of by the Applicant. In exchange for disclosing the inventive concepts contained herein, the Applicant desires all patent rights afforded by the appended claims. Therefore, it is intended that the appended claims include all modifications and alterations to the full extent that they come within the scope of the following claims or the equivalents thereof.

What is claimed is:

1. A videoconferencing unit comprising:
a processor, a memory coupled to the processor by a bus, one or more audio/video components for handling videoconferencing, one or more network interfaces for coupling the videoconferencing unit to one or more networks, and a ping module;
the ping module being configured to send an echo response request over a network to a second videoconferencing unit.

2. The videoconferencing unit of claim 1 wherein:
the ping module is configured, upon receiving an echo response within a configurable amount of time, to identify the second videoconferencing system as reachable.

3. The videoconferencing unit of claim 2, wherein:
the ping module is configured, upon not receiving an echo response from the second videoconferencing unit within a configurable amount of time, to send another echo response request to the second videoconferencing unit.

4. The videoconferencing unit of claim 3, wherein:
the ping module is configured, upon not receiving an echo response from the second videoconferencing unit within a configurable number of sent echo response requests, to identify the second videoconferencing system as unreachable.

5. The videoconferencing unit of claim 1, wherein:
the ping module is configured, upon not receiving an echo response from the second videoconferencing unit within a configurable amount of time, to identify the second videoconferencing system as unreachable.

6. The videoconferencing unit of claim 5, wherein:
the videoconferencing unit is configured to display the reachability status of the second videoconferencing unit.

7. The videoconferencing unit of claim 6, wherein:
the videoconferencing unit is configured to display videoconferencing units identified as reachable differently than videoconferencing units identified as unreachable.

8. The videoconferencing unit of claim 6, wherein:
the videoconferencing unit is configured to display videoconferencing units identified as reachable and not display videoconferencing units identified as unreachable.

9. The videoconferencing unit of claim 1, wherein:
the videoconferencing unit is configured to initiate a videoconference call via at least one of the network interfaces in dependence upon the reachability status of the second videoconferencing unit.

10. The videoconferencing unit of claim 1, wherein:
the ping module is configured to receive through one or more network interfaces an echo response request sent over a network from a second videoconferencing unit and to automatically return an echo response to the second videoconferencing unit.

11. A videoconferencing unit comprising:
a processor, a memory coupled to the processor by a bus, one or more audio/video components for handling videoconferencing, one or more network interfaces for coupling the videoconferencing unit to one or more networks, and a ping module;
the ping module being configured to receive an echo response request sent over a network from a second videoconferencing unit and to automatically return an echo response to the second videoconferencing unit.

12. A method of determining the reachability status of a remote videoconferencing unit, the method comprising:
sending an echo response request through a network to a second videoconferencing address corresponding to a second videoconferencing unit, and;
upon receiving an echo response from the second videoconferencing address within a configurable amount of time, identifying the second videoconferencing system associated with the second videoconferencing address as reachable.

13. The method of claim 12, further comprising:
sending, upon not receiving an echo response from the second videoconferencing unit within a configurable amount of time, another echo response request to the second videoconferencing address associated with the second videoconferencing unit.

14. The method of claim 13, further comprising:
identifying, upon not receiving an echo response from the second videoconferencing unit within a configurable number of sent echo response requests, the second videoconferencing system associated with the second videoconferencing address as unreachable.

15. The method of claim 12, further comprising:
identifying, upon not receiving an echo response from the second videoconferencing unit within a configurable amount of time, the second videoconferencing system associated with the second videoconferencing address as unreachable.

16. The method of claim 15, further comprising:
identifying reachable videoconferencing units on a display screen to facilitate a user selecting the videoconferencing units as potential videoconference participants.

17. The method of claim 16, wherein:
identifying reachable videoconferencing units on a display screen further comprises displaying videoconferencing units identified as reachable differently than videoconferencing units identified as unreachable.

18. The method of claim 16, wherein:
identifying reachable videoconferencing units on a display screen further comprises displaying videoconferencing units identified as reachable and not displaying videoconferencing units identified as unreachable.

19. A method of identifying to a remote videoconferencing unit the reachability status of a videoconferencing unit, the method comprising:
receiving at a videoconferencing unit an echo response request sent from a remote videoconferencing unit; and
automatically returning an echo response to the remote videoconferencing unit.
